(19) United States
(12) Patent Application Publication
(10) Pub. No.: US 2024/0316481 A1
(43) Pub. Date: Sep. 26, 2024

(54) PIPING APPARATUS FOR STRAINING AND METHOD FOR SAME

(71) Applicant: WATTS REGULATOR CO., NORTH ANDOVER, MA (US)

(72) Inventors: Joseph Michael Burke, Deerfield, NH (US); Ian David Baynes, Merrimac, MA (US); Thomas Jeffery Rudnick, Springfield, MO (US); Joshua Raymund Saber, Chelmsford, MA (US)

(73) Assignee: WATTS REGULATOR CO., NORTH ANDOVER, MA (US)

(21) Appl. No.: 18/731,036

(22) Filed: May 31, 2024

Related U.S. Application Data
(63) Continuation of application No. PCT/US22/51678, filed on Dec. 2, 2022.
(60) Provisional application No. 63/285,830, filed on Dec. 3, 2021.
(60) Provisional application No. 63/327,192, filed on Apr. 4, 2022.

(51) Int. Cl. B01D 29/60; B01D 29/11; B01D 29/66; B01D 35/02; B01D 35/143

(52) U.S. Cl. CPC B01D 29/606; B01D 29/11; B01D 29/668; B01D 35/02; B01D 35/1435; B01D 2201/165; B01D 2201/54

(57) ABSTRACT

A piping apparatus is provided, which comprises a strainer comprising a strainer housing including a strainer branch; wherein the strainer housing includes one or more pressure sensors; wherein, when a strainer element is in the strainer branch, at least one pressure sensor of the plurality of pressure sensors is fixed to the strainer housing at a location upstream of the strainer element and/or is fixed to the strainer housing at a location downstream of the strainer element.

### CROSS REFERENCE TO RELATED APPLICATIONS

This is a continuation of PCT/US22/51678 filed 2 Dec. 2022, which claims benefit of U.S. Ser. No. 63/285,830, filed 3 Dec. 2021, and U.S. Ser. No. 63/327,192, filed 4 Apr. 2022, all of which are fully incorporated herein by reference.

### FIELD

The present disclosure relates to piping apparatus and systems, and more particularly strainers.

### BACKGROUND

Strainers, for example, wye (“Y”) and basket strainers, mechanically remove solids from flowing fluid (e.g., liquid, steam (vapor) or gas) piping systems, particularly with use of a perforated or wire mesh strainer element (e.g., screen) contained within the strainer. Solids may include particulate, such as grave or sand, or other debris. Removal of such solids from supply lines, for example, may protect downstream pipeline (in-line) process equipment against potential damage by the solids. The downstream process equipment may include equipment such as pumps, control valves, meters, regulators and traps.

Strainers may be cleaned with or without disassembly of the strainer. If the strainer is cleaned with disassembly, the pipeline is generally shut-down (e.g., depressurized and fluid removed), upon which time a strainer cap is removed from the strainer housing to provide access to the strainer element within the pipeline. After removing and cleaning the strainer element, the strainer element and the strainer cap are reinstalled and the pipeline reopened.

For cleaning without disassembly, the strainer may be fitted with what is known as a blow-down connection, which may permit the strainer to be cleaned without disassembly. In such instance, a downstream blow-down valve may be located in piping which connected to the strainer cap, and more particularly which establishes a fluid passage extending through the strainer cap. The strainer element may then be cleaned by manually opening the downstream blow-down valve, without shutting off the fluid flow or disassembling the strainer. When the blow-down valve is opened, the solid material trapped inside the strainer element may drain out, upon which time the valve may be reclosed.

### SUMMARY

IN In one embodiment of the present disclosure, a piping apparatus is provided, which comprises a strainer comprising a strainer housing including a strainer branch; wherein the strainer branch is configured to contain a strainer element in the strainer branch; wherein the strainer housing has a longitudinal length extending from the inlet to the outlet, and the longitudinal length extends along a strainer housing longitudinal axis; wherein the strainer branch has a longitudinal length which extends along a strainer branch longitudinal axis; wherein the strainer housing longitudinal axis and the strainer branch longitudinal axis are at an angle (A) with respect to one another; wherein the strainer housing includes one or more pressure sensors; wherein, when the strainer element is in the strainer branch, at least one pressure sensor is fixed to the strainer housing at a location upstream of the strainer element and/or is fixed to the strainer housing at a location downstream of the strainer element.

In another embodiment of the present disclosure, a method of operating a piping apparatus is provided, which comprises obtaining a strainer comprising a strainer housing including a strainer branch, wherein the strainer branch is configured to contain a strainer element in the strainer branch; wherein the strainer housing has a longitudinal length extending from the inlet to the outlet, and the longitudinal length extends along a strainer housing longitudinal axis; wherein the strainer branch has a longitudinal length which extends along a strainer branch longitudinal axis; wherein the strainer housing longitudinal axis and the strainer branch longitudinal axis are at an angle (A) with respect to one another; wherein the strainer housing includes one or more pressure sensors; wherein, when the strainer element is in the strainer branch, at least one pressure sensor is fixed to the strainer housing at a location upstream of the strainer element and/or is fixed to the strainer housing at a location downstream of the strainer element; obtaining a control unit; establishing electronic communication between the plurality of pressure sensors and the control unit; receiving at least one signal from the one or more pressure sensors at the control unit; and determining pressure being applied to the one or more pressure sensors by fluid within the strainer based on the at least one signal with the control unit.

In another embodiment of the present disclosure, a piping apparatus includes a strainer, a valve arrangement, and one or more flushing valves. The strainer includes a strainer housing comprising an inlet passage, an outlet passage, and a first and a second strainer chamber each including a strainer element. The valve arrangement is configured to selectively fluidly couple the inlet passage and the outlet passage to the first strainer chamber when in a first configuration and selectively fluidly couple the inlet passage and the outlet passage to the second strainer chamber when in a second configuration. The flushing valves are configured to selectively provide a flow of a flushing fluid through at least a portion of a selected one or more of the first and/or second strainer chambers to remove contaminants/debris from the strainer element within the selected one or more of the first and/or second strainer chambers. The pressure sensors are configured to be located upstream of the first and/or second strainer elements and/or located downstream of the first and/or second strainer elements.

The piping apparatus may optionally include a controller configured to enter into a cleaning cycle based on an output of the one or more pressure sensors, wherein during the cleaning cycle, the control unit is configured to cause the valve arrangement to transition from the first configuration to the second configuration. During the cleaning cycle, the control unit may be further configured to cause the flushing valves to provide the flow of the flushing fluid to the first strainer chamber. Fluid may be configured to flow into the inlet passage and exit the outlet passage substantially uninterrupted while the valve arrangement transitions from the first configuration to the second configuration and the one or more flushing valves provide the flow of the flushing fluid to the first strainer chamber.

### FIGURES

The above-mentioned and other features of this disclosure, and the manner of attaining them, will become more apparent and better understood by reference to the following description of embodiments described herein, taken in conjunction with the accompanying drawings, wherein:

FIG. 1 is a perspective view of a piping apparatus of a piping system, including a strainer and a strainer control unit according to the present disclosure;

FIG. 2 is a side view of the piping apparatus of a piping system of FIG. 1;

FIG. 3A is a perspective view of the strainer control unit of FIG. 1;

FIG. 3B is a side view of the strainer control unit of FIG. 1;

FIG. 3C is a front view of the strainer control unit of FIG. 1;

FIG. 4 is an exploded view of the strainer control unit of FIG. 1;

FIG. 5A is a perspective view of an electronic circuit board of the strainer control unit of FIG. 1;

FIG. 5B is a plan view of the electronic circuit board of the strainer control unit of FIG. 1;

FIG. 5C is a side view of the electronic circuit board of the strainer control unit of FIG. 1.

FIG. 6A is a schematic view of a piping apparatus of a piping system in a first flow configuration.

FIG. 6B is a schematic view of the piping apparatus of the piping system in a second flow configuration.

FIG. 7 is a top view of a duplex strainer according to the present disclosure.

FIG. 8 is a side view of the duplex strainer of FIG. 7.

FIG. 9 is a partial cross-sectional view of the duplex strainer of FIG. 7.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

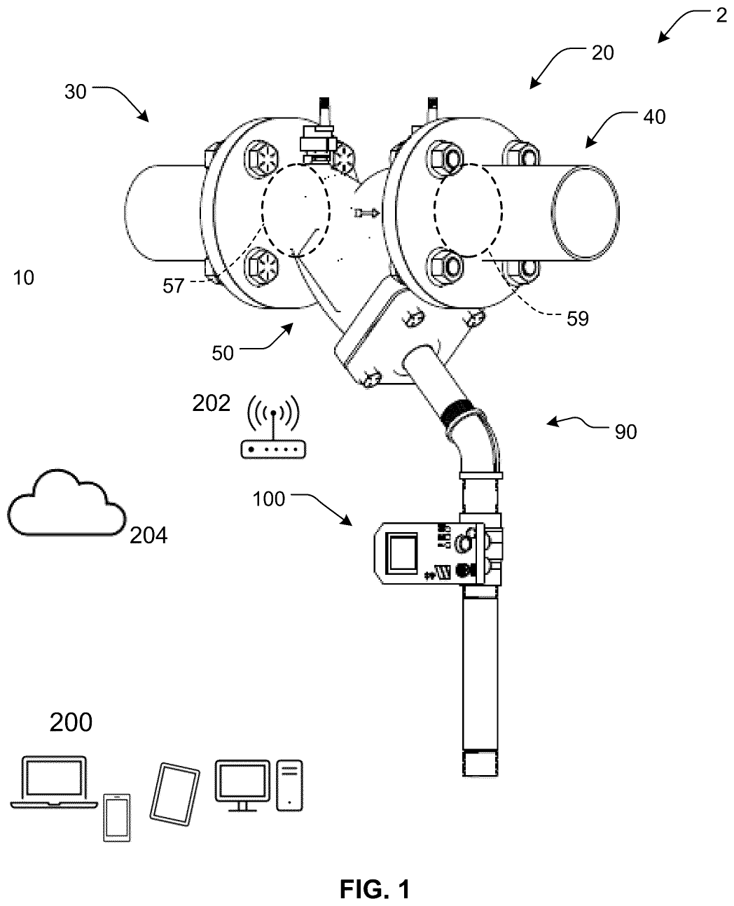

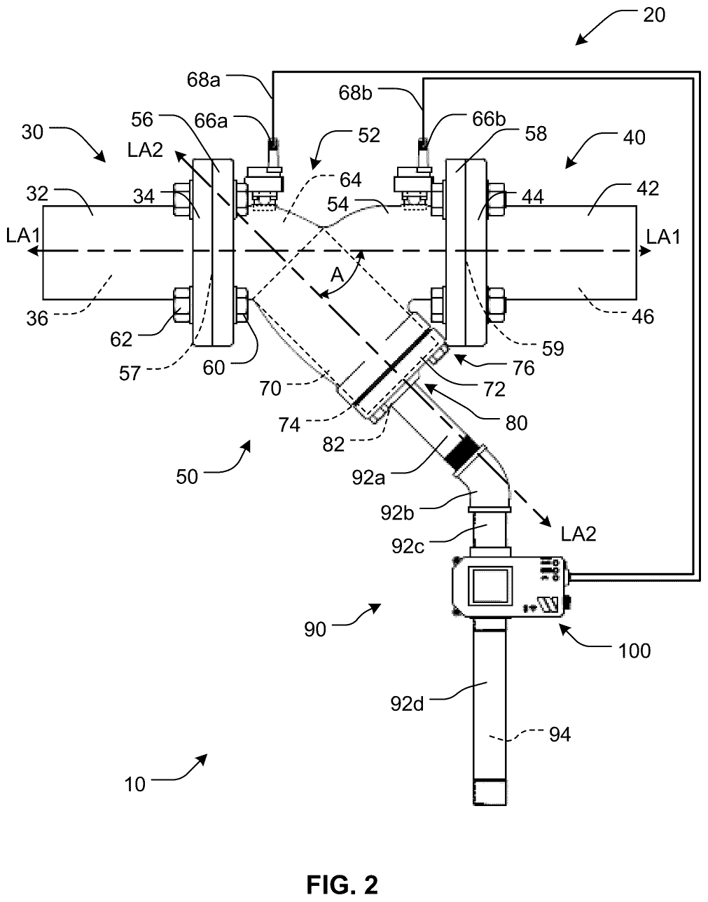

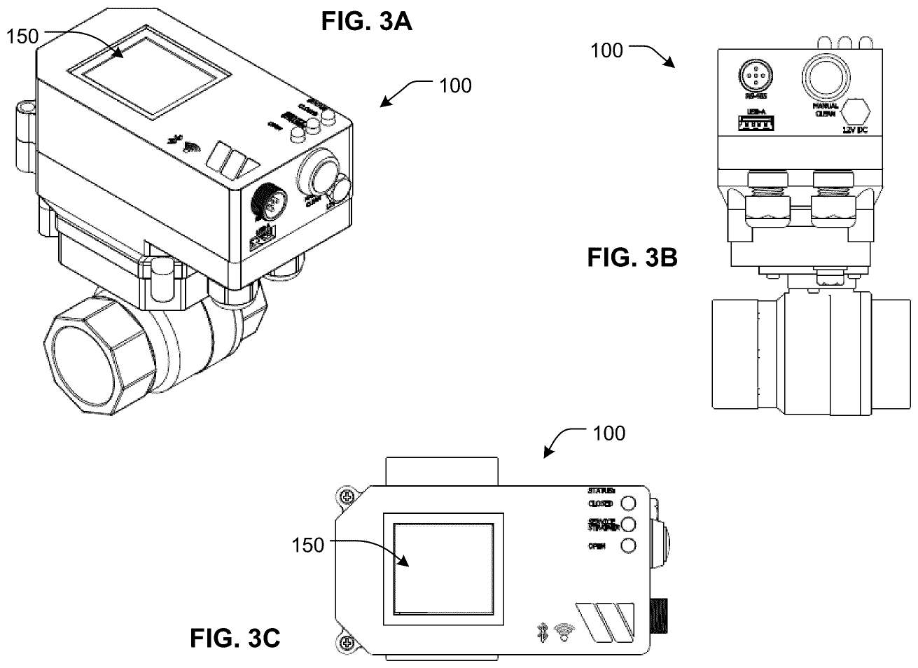

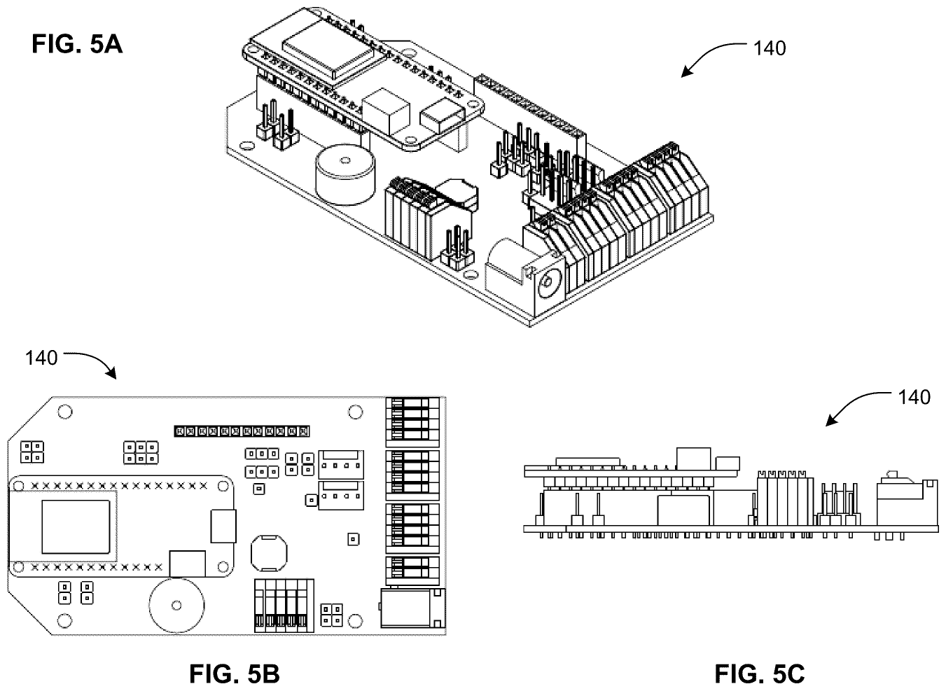

Referring now to FIGS. 1-5C, and predominately FIG. 2, there is shown a piping apparatus 10 according to the present disclosure. As shown, piping apparatus 10, of a piping system 2, comprises a pipeline 20. Pipeline 20 comprises an upstream (inlet) pipe 30 comprising a tubular (cylindrical) wall 32 and an upstream (inlet) mounting flange 34 (e.g., an annular (ring) mounting flange), through which an upstream (inlet) fluid flow passage 36 extends.

Pipeline 20 further comprises a downstream (outlet) pipe 40 comprising a tubular (cylindrical) wall 42 and a downstream (outlet) mounting flange 44 (e.g., an annular (ring) mounting flange), through which a downstream (outlet) fluid flow passage 46 extends.

Disposed between upstream (inlet) pipe 30 and downstream (outlet) pipe 40 is an electronic strainer 50. In the illustrated examples, the strainer 50 is shown as a wye (“Y”) strainer 50; however, it should be appreciated that the strainer 50 is not limited to wye (“Y”) strainers and that the strainer 50 may include any strainer design known to those skilled in the art. As shown, electronic strainer 50 has a strainer housing 52 comprising a strainer (tubular) wall 54 disposed between an upstream (inlet) mounting flange 56 (e.g., an annular (ring) mounting flange) and a downstream (outlet) mounting flange 58 (e.g., an annular (ring) mounting flange).

As shown, the inlet mounting flange 56 of the electronic strainer 50 is removably connected to the mounting flange 34 of upstream (inlet) pipe 30 by threaded fasteners 60 and 62 (bolt 60 and nut 62), while the outlet mounting flange 58 of the electronic strainer 50 is removably connected to the mounting flange 44 of downstream (outlet) pipe 40 by threaded fasteners 60 and 62 (bolt 60 and nut 62). Of course, the flanges 34, 44, 56, 58 may be coupled together in any manner known to those skilled in the art including, but not limited to, clamps (e.g., band clamps such as V-band clamps) or the like.

Within strainer housing 52 is a fluid flow passage 64 which extends through tubular wall 54, inlet mounting flange 56 and outlet mounting flange 58. Inlet mounting flange 56 defines an upstream inlet 57 (see FIG. 1, e.g., a circular upstream inlet) to fluid flow passage 64, while outlet mounting flange 58 defines a downstream outlet 59 (see FIG. 1, e.g., a circular downstream outlet) to fluid flow passage 64.

Contained within a strainer branch 76 of the strainer housing 52/fluid flow passage 64 is a strainer element 70, which may comprise a reusable mesh screen (e.g., a cylindrical wire mesh) or a perforated plate, which may also be referred to as a basket. Strainer element 70 may have a mesh size (U.S. Standard Mesh scale), for example, in a range of 16 mesh (0.047 inch or 1194 microns) to 25 mesh (0.028 inch or 711 microns). Strainer 70 may be formed of metal (such as, but not limited to, stainless steel or the like), plastic, and/or ceramics.

As shown, strainer branch 76/strainer element 70 have a longitudinal axis LA2 which is at an angle A with respect to the longitudinal axis LA1 of the strainer housing 52 extending parallel with a longitudinal length of the strainer 50, from the upstream mounting flange 56 to the downstream mounting flange 58. As shown, the angle A is an acute angle A (which may be in a range of 5 degrees to 85 degrees, and more particularly 20 degrees to 70 degrees) as measured between the downstream side of the strainer element 70 and the outlet mounting flange 58. It may be appreciated; however, that the angle A may be an obtuse angle or a perpendicular angle (e.g., the strainer branch 76 may for a “T” relative to the longitudinal axis LA1 of the strainer housing 52). As such, the strainer 50 may include a “Y” strainer, a “T” strainer, and/or a basket strainer. The strainer 50 of the present disclosure is therefore applicable to any strainer that has an inlet, an outlet, and a drain that would allow debris to be flushed out of strainer. In a basket strainer, the screen would open from the bottom to allow debris to exit through drain. As shown, the strainer element 70 is arranged such that fluid flowing through the fluid flow passage 64 within the strainer housing 52 flows through the strainer element 70. In such manner, solid matter within fluid, such as solid particulate (e.g., gravel, sand) entering the electronic strainer 50 from upstream (inlet) pipe 30 may be constrained and contained within the strainer element 70 and inhibited from entering downstream (outlet) pipe 40.

As shown, electronic strainer 50 further comprises one or more sensors 66a, 66b. The sensors 66a, 66b may be used to determine pressure within fluid flow passage 64 with a control unit 100, as explained in greater detail below. Alternatively (or in addition), one or more of the sensors 66a, 66b may include a temperature sensor. As shown, sensors 66a, 66b may be electronically coupled to control unit 100 via wire communication lines 68a, 68b, respectively, or the sensors 66a, 66b may be wirelessly electronically coupled to control unit 100, in which case the sensors 66a, 66b each include a wireless transmitter to transmit data to the control unit 100. While two sensors 66a, 66b are shown, it should be appreciated that the electronic strainer 50 may include only one sensor or more than two sensors.

Strainer housing 52 further includes a removable strainer cap 72 which covers an ingress/egress aperture (e.g., circular ingress/egress) 74 formed in strainer wall 54. Upon removal of strainer cap 72, the strainer element 70 may be removed from the strainer housing 52, at which time the strainer element 70 may be cleaned or replaced, and subsequently reinstalled with the strainer cap 72.

Strainer housing 52 and/or strainer cap 72 further comprises an outlet port 80, which comprises an aperture (e.g., a cylindrical threaded aperture and/or through-hole) 82. As shown a tubular conduit 90 is connected to the outlet port 80. The tubular conduit 90 may be provided by one or more tubular members 92a, 92b, 92c and 92d, which define at least a portion of a fluid flow passage 94.

As set forth above, electronic strainer 50 comprises one or more pressure sensors 66a and 66b, which may be used to determine pressure within fluid flow passage 64 with the control unit 100. As shown pressure sensor 66a (which may be referred to as an upstream pressure sensor) is fixed, particularly by being mounted, to the strainer housing wall 54 upstream of the strainer element 70/strainer branch 76 such that pressure within fluid flow passage 64 may be determined upstream of strainer element 70/strainer branch 76, while pressure sensor 66b (which may be referred to as a downstream pressure sensor) is fixed, particularly by being mounted, to the strainer housing wall 54 downstream of the strainer element 70/strainer branch 76 such that pressure within fluid flow passage 64 may be determined downstream of strainer element 70/strainer branch 76.

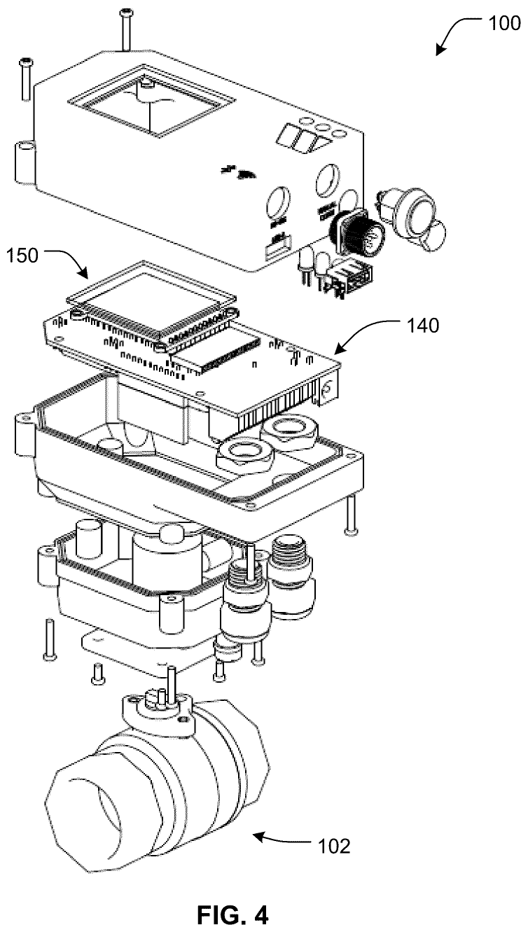

In at least one example, the control unit 100 determines, based at least in part on signals (e.g., voltage) received from the pressure sensors 66a, 66b, that a difference in pressure being applied to the two pressure sensors 66a, 66b by fluid in the fluid flow passage 64 exceeds a pre-set pressure difference. In response to this determination, the control unit 100 may operate to initiate a self-cleaning cycle in which a valve 102 of the control unit 102 (see, e.g., FIG. 4), which is disposed in the fluid flow passage 94, is opened from a closed position. In at least some examples, the valve 102 is disposed coupled to one or more of tubular members 92a, 92b, 92c and 92d,

When valve 102 opens, the fluid line pressure within fluid flow passage 36/64 forces solid material disposed within the strainer element 70 out of the strainer element 70/fluid flow passage 64 and into fluid flow passage 94, past valve 102, at which time the valve 102 may be reclosed. The valve 102 may be opened for a pre-set time period (duration) of less than 30 seconds, such as 5-25 seconds and more particularly 10-20 seconds. After the valve 102 is closed by the control unit 100, control unit 100 may reenter a monitoring mode, to monitor the pressure of fluid in the fluid flow passage 64 being sensed by the two pressure sensors 66a, 66b.

If the difference in pressure by fluid in the fluid flow passage 64 sensed by the two pressure sensors 66a, 66b exceeds the pre-set pressure difference a second time, within a pre-set time period/duration (e.g., but not limited to, less than 5 minutes), the control unit 100 may repeat the foregoing self-cleaning cycle for a second. Similarly, if the difference in pressure being applied to the two pressure sensors 66a, 66b by fluid in the fluid flow passage 64 exceeds the pre-set pressure difference a third time or additional time within a pre-set time period/duration (e.g., but not limited to, less than 5 minutes), the control unit 100 may repeat the foregoing self-cleaning cycle for a third or additional time.

After at least one (two or three) unsuccessful cleanings (i.e., pressure on upstream sensor 66a is not within a pre-set pressure difference (e.g., 5 psi or less) of the pressure on downstream sensor 66b), the control unit 100 may operate to report/communicate an alert of such externally.

It should be appreciated; however, that the control unit 100 may initiate a self-cleaning cycle based on only the upstream pressure 66a. For example, the control unit 100 may initiate a self-cleaning cycle based on the output of upstream pressure 66a meeting and/or exceeding a high-pressure threshold (e.g., which may be indicative of a blockage). Alternatively, the control unit 100 may initiate a self-cleaning cycle based on only the downstream pressure 66b. For example, the control unit 100 may initiate a self-cleaning cycle based on the output of downstream pressure 66b meeting and/or exceeding a low-pressure threshold (e.g., which may be indicative of a blockage).

Control unit 100 may further comprise a micro-processor 110, a non-transitory computer-readable storage medium 120 (e.g., memory) and a communication element 130, which may all be incorporated on one or more electronic circuit boards 140 of the control unit 100.

Sensors 66a, 66b may be electrically/electronically and operationally connected, particularly via electronic circuit board 140, to micro-processor 110 and non-transitory computer-readable storage medium 120 to record operational data, which may be stored within control unit 100. Such may all be powered by a power source 160 (e.g., one or more batteries and/or hard wired to a power grid).

The operation data may also be accessed by and/or communicated to at least one remote electronic device 200 (see, e.g., FIG. 1), which may be part of a computer communication network, at near real time with communication element 130. In the event the operational data is communicated to the remote electronic device(s) 200 of the communication network, such may also be stored in a non-transitory computer-readable storage medium of the remote electronic device(s) 200 of the communication network or communicated and stored on other remote electronic device(s) 200 of another communication network.

The at least one remote electronic device 200 may comprise a computer such as a desktop computer, a portable computer such as a laptop computer, a notebook computer, a netbook/tablet computer (with or without a keyboard such as an iPad™), a personal digital assistant (PDA), a wearable computer, a cellphone computer or other handheld computer (e.g., smartphone).

As illustrated in FIG. 1, the communication element 130 may electronically communicate with (transmit to and/or receive electronic communication from) the remote electronic device(s) 200 of the communication network using wireless communication standards and protocols (e.g., Wi-Fi, Bluetooth, cellular). As such, it should be understood that the communication element 130 of control unit 100 may particularly be either a one-way communication element (e.g., transmitter) or a two-way communication element (e.g., transmitter and/or receiver, such as a transceiver) for allowing the electronic strainer 50, and more particularly control unit 100, to communicate with the remote electronic devices (s) 200 of computer network. For example, the control unit 100 may communicate using Wi-Fi to a modem 202 which in turn connects the control unit to an Internet-based application software as a service, represented by a cloud 204, which in turn is accessed by the remote electronic devices (s) 200 for communicating with control unit. Alternatively, the control unit 100 may connect directly to the cloud 204 using cellular communications or connect directly to the remote electronic devices (s) 200 using Bluetooth. Thus, electronic strainer 50, and more particularly control unit 100, may contain all the computer (software) application programs and electronic circuitry to enable communication therebetween, such as signals (e.g., voltage) which may include data (e.g., raw, interpreted, and binary). In addition to one or more computer processors, such circuitry may include digital and analog integrated circuits, resistors, capacitors, transistors and other semiconductors and other electronic components known to those skilled in the art.

In the foregoing manner, electronic strainer 50, and more particularly control unit 100 may transmit data (e.g., voltage signals representative of pressure measurements of fluid) via the communication element 130 to the remote electronic device(s) 200 of the communication network. The remote electronic devices(s) 200 of the computer network, and more particularly (micro) processor(s) of the remote electronic devices(s) 200 may then convert the data/signals to an output (e.g., graph and/or numerical display) representative of detected/measured/recorded pressure readings using hardware and/or software including an algorithm, which may be shown on an output display screen. A display screen may be understood as a computer output surface and projecting mechanism that shows text and often graphic images to the user of the remote electronic devices 200, using a cathode ray tube (CRT), liquid crystal display (LCD), light-emitting diode (LED), gas plasma (GS), or other image projection technology. The display may be a touch activated screen.

Alternatively, the processor 110 of the electronic strainer 50, and more particularly the control unit 100, may convert the data/signals to an output (e.g., graph and/or numerical display) representative of detected/measured/recorded pressure readings using hardware and/or software including an algorithm. The output graph and/or numerical display of detected/measured/recorded pressure readings may then be transmitted to the remote electronic devices(s) 200 of the communication network for display on a computer display of the remote electronic devices(s) 200 of the communication network, or displayed on the electronic strainer 50, and more particularly the control unit 100.

In other embodiments, electronic strainer 50, and more particularly control unit 100, may include its own output display 150 which may be a numeric display of the detected/measured/recorded pressure readings The output display 150 may be an LED display, which may be similar in size to that of a digital watch.

In light of the foregoing, piping system 2/piping apparatus 10/electronic strainer 50 oversight personnel (which may include management personnel and/or maintenance (repair) personnel) may wirelessly connect with the electronic strainer 50, and more particularly control unit 100 using a remote electronic device 200, particularly a cellphone computer or other handheld computer (e.g., smartphone) which has a software (mobile) application which will communicate with software of the electronic strainer 50, and more particularly control unit 100, to access operational data of the electronic strainer 50. The operational data may or may not have been previously reported as part of an alert. In other words, oversight personnel may access live or stored operational data of the electronic strainer 50 with remote electronic devices 200, and more particularly control unit 100, regardless of where the strainer 50 has undergone one or more unsuccessful cleaning cycles. Moreover, oversight personnel may also schedule and/or initiate remote cleaning of the electronic strainer 50 with or without having received an alert. The personnel may also remotely configure the pressure differential setpoint, cleaning cycle duration, and valve opening and closing times with the remote electronic devices 200.

As set forth above, when the electronic strainer 50, and more particularly the control unit 100, undergoes at least one (e.g., two or three) unsuccessful cleanings (i.e., pressure on upstream sensor 66a is not within the pre-set pressure difference of downstream sensor 66b), the control unit 100 may operate to report/communicate an alert of such to at least one remote electronic device 200 (which may be part of a computer communication network) that is stored in a non-transitory computer-readable storage medium of the remote electronic device(s) of the communication network. For example, the operational data may be reported to a backflow monitoring service (e.g., Syncta) which may store and view the operational reports and report such to piping system 2/piping apparatus 10/electronic strainer 50 oversight personnel and/or initiate one or more further cleaning cycles with or without having received an alert.

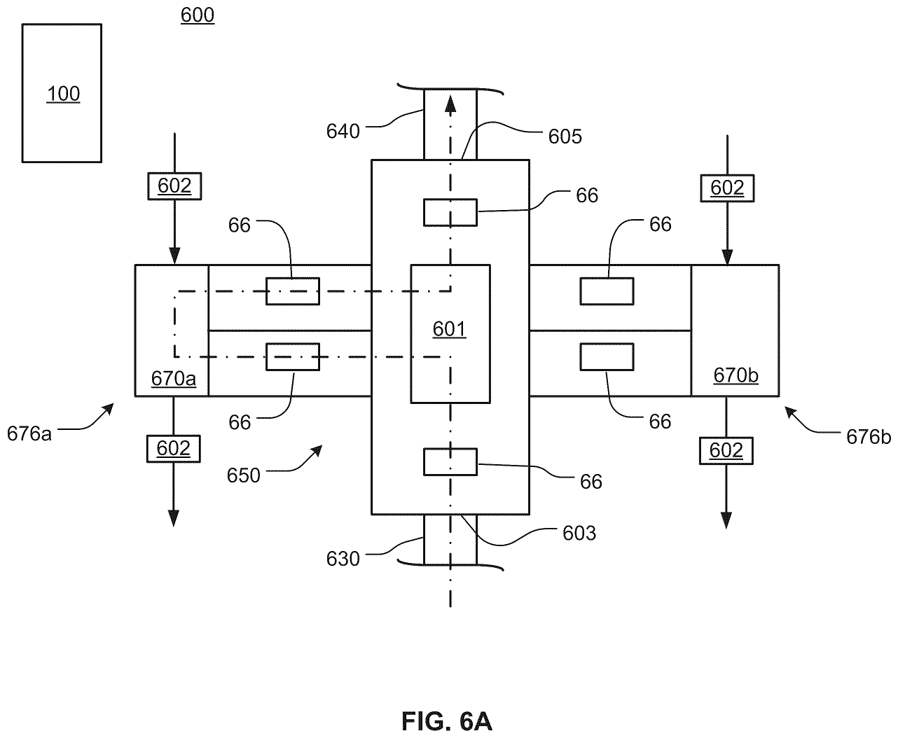

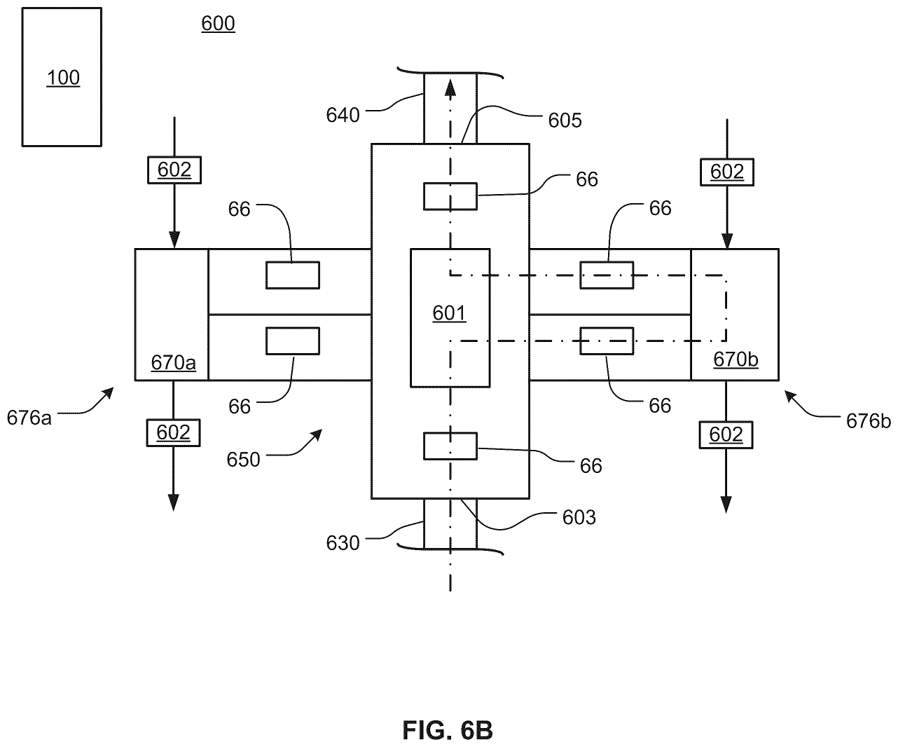

Turning now to FIGS. 6A-6B, another example of a piping system 600 consistent with the present disclosure is generally illustrated. The piping system 600 comprises an upstream (inlet) pipe 630 and a downstream (outlet) pipe 640. Disposed between upstream (inlet) pipe 630 and downstream (outlet) pipe 640 is an electronic strainer 650. In the illustrated examples, the strainer 650 is a duplex strainer having an inlet passage 603 configured to receive fluid from the upstream pipe 630 and an outlet passage 605 downstream of the inlet passage 603 and configured to provide the fluid to the downstream pipe 640. Duplex Strainers are particularly suited for application where the piping system cannot be shut down for basket cleaning. The duplex strainer 650 includes a plurality of strainer elements 670 (e.g., a first and a second screened basket 670a, 670b) that trap debris, with a valve arrangement 601 that switches between the two strainer elements 670a, 670b. The strainer elements 670 may be provided in different strainer branches (also referred to herein as strainer chambers) 676. The valve arrangement 601 may be configured to selectively fluidly couple the inlet passage 603 to one or more of the strainer elements 670. For example, the valve arrangement 601 may be configured to selectively fluidly couple the inlet passage 603 to only one of the strainer elements 670 at time. As such, the valve arrangement 601 may be configured to allow a first strainer element 670a (located in a first strainer chamber 676a) to be used while a second strainer element 670b (located in a second strainer chamber 676b) is cleaned, thereby allowing the duplex strainer 650 to continue to operate without interruption in flow as generally illustrated in FIG. 6A.

As shown, electronic strainer 650 further comprises one or more sensors 66. The sensors 66 may be used to determine pressure within the electronic strainer 650 with a control unit 100, as explained herein. Alternatively (or in addition), one or more of the sensors 66 may include a temperature sensor. As described herein, sensors 66 may be electronically coupled to control unit 100 via wire communication lines or the sensors 66 may be wirelessly electronically coupled to control unit 100, in which case the sensors 66 each include a wireless transmitter to transmit data to the control unit 100. While multiple sensors 66 are shown, it should be appreciated that the electronic strainer 650 may include only one sensor or more than two sensors.

In at least one example, the electronic strainer 650 may include one or more sensors 66 configured to provide a signal representative of the pressure in the inlet passage 603 and/or the upstream pipe 630 as well as one or more sensors 66 configured to provide a signal representative of the pressure in the outlet passage 605 and/or the downstream pipe 640 to a control unit 100. The control unit 100 may utilize any combination of these upstream and/or downstream sensors 66 to determine a differential pressure and/or pressure threshold as explained herein. Alternatively (or in addition), each strainer chamber 676 may include one or more sensors 66 configured to provide a signal representative of the pressure upstream of the strainer element 670 as well as one or more sensors 66 configured to provide a signal representative of the pressure downstream of the strainer element 670. The control unit 100 may utilize any combination of these upstream and/or downstream sensors 66 to determine a differential pressure and/or pressure threshold as explained herein.

Regardless of the sensors 66 used, the controller 100 may be configured to determine when to initiate a self-cleaning cycle based, at least in part, on signal(s) (e.g., voltage) received from the pressure sensor(s) 66. For example, the controller 100 may determine that a difference in pressure being applied to two pressure sensors 66 associated with the electronic strainer 650 and/or piping system 600 exceeds a pre-set pressure difference or a pre-set pressure threshold. In response to this determination, the control unit 100 may operate to initiate the self-cleaning cycle. Upon initiation of the self-cleaning cycle, the controller 100 may be configured to active the valve arrangement 601 to change the flow path of the fluid through the electronic strainer 650 from the strainer element 670 which triggered the self-cleaning cycle (i.e., the strainer element 670 which was in use and which is associated with the pre-set pressure difference or a pre-set pressure threshold) to another one of the strainer elements 670 associated with the electronic strainer 650. For example, the controller 100 may active the valve arrangement 601 to change the fluid flow path passing through the strainer element 670a as shown in FIG. 6A to a fluid flow path passing through strainer element 670b as shown in FIG. 6B.

The controller 100 may also be configured to active one or more flushing valves 602 to initiate a cleaning/flushing of the strainer element 670 which triggered the self-cleaning cycle. The flushing valves 602 may be configured to provide a flow of a flushing fluid (including, but not limited to, water or the like) through at least a portion of the strainer chamber 676 to remove contaminants/debris from the strainer element 670 which triggered the self-cleaning cycle. For example, the flushing fluid may flow pass one side of the strainer element 670 or through at least a portion of the strainer element 670. In the illustrated example, each strainer element 670 may include an upstream flushing valve 602 and a downstream flushing valve 602, though it should be appreciated that other arrangements of the flushing valves 602 is possible.

Because the flow path through the electronic strainer 650 is able to be changed, the electronic strainer 650 may automatically clean/regenerate the strainer element 670 which triggered the self-cleaning cycle to another strainer element 670 without interrupting the overall flow through the electronic strainer 650. The strainer element 670 which triggered the self-cleaning cycle may therefore be regenerated and reused thereafter and the process may be repeated indefinitely. The electronic strainer 650 is also therefore able to clean/regenerate the strainer elements 670 without having to remove the strainer elements 670 from the electronic strainer 650. The controller 100 may otherwise function in a manner similar to that described above.

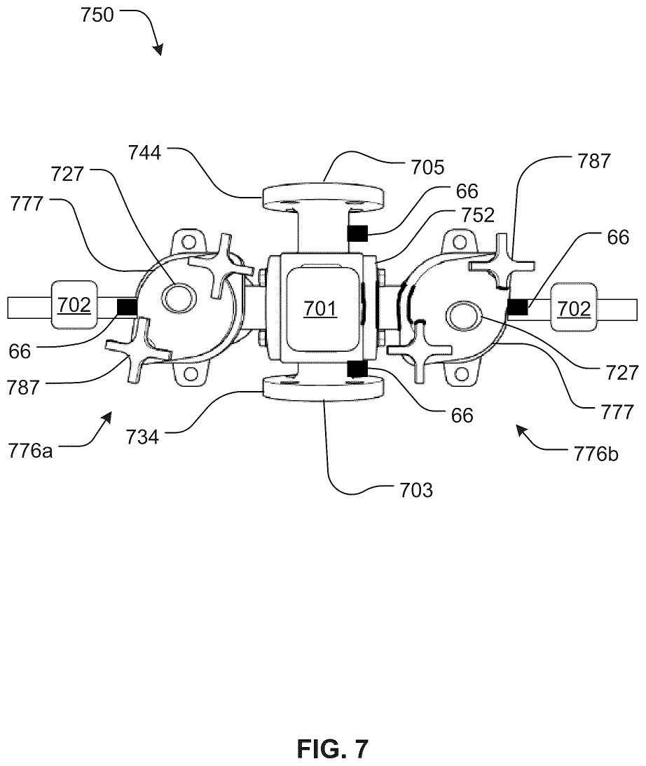

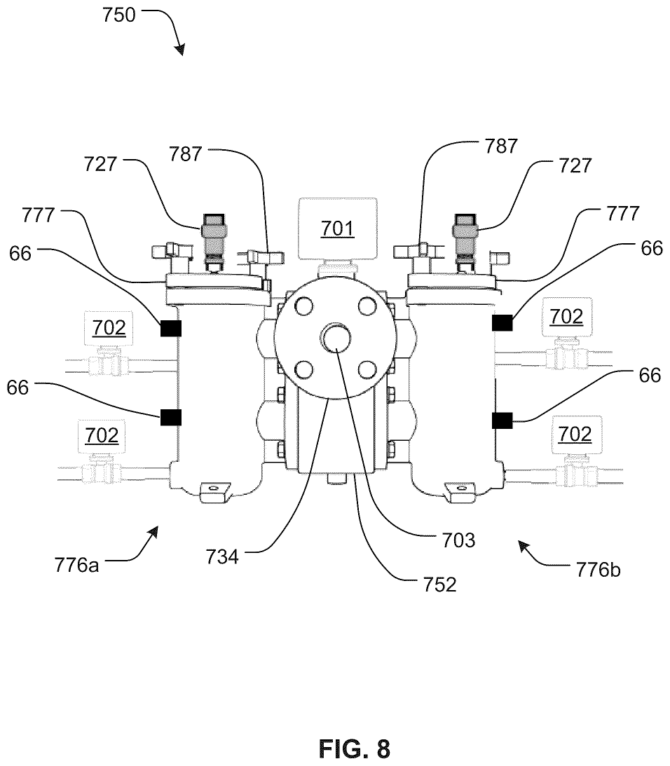

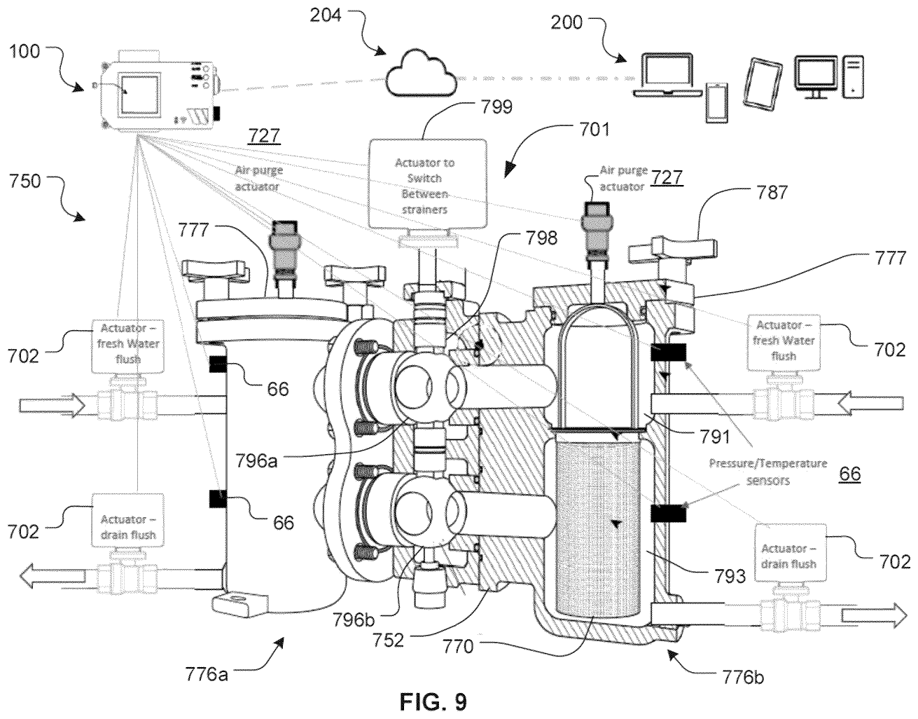

Turning now to FIGS. 7-9, another example of duplex strainer consistent with the present disclosure is generally illustrated. In particular, FIG. 7 is a top view of the duplex strainer 750, FIG. 8 is a side view of the duplex strainer 750, and FIG. 9 is a partial cross-sectional view of the duplex strainer 750. The electronic duplex strainer 750 has a strainer housing 752 comprising an inlet passage 703, outlet passage 705, as well as a first and a second strainer chambers 776a, 776b. As seen in FIG. 7, the inlet passage 703 may include upstream (inlet) mounting flange 734 and the outlet passage 705 may include a downstream (outlet) mounting flange 744. With reference to FIGS. 7-9, the strainer chambers 776a, 776b may include a removable lid or cover 777 configured provide access to the strainer elements 770 disposed within the strainer chambers 776a, 776b. The removable lid or cover 777 may be secured using one or more fasteners 787.

The electronic strainer 750 may include one or more pressure and/or temperature sensors 66 configured to generate signals to be transmitted to a control unit 100 as explained herein. The electronic strainer 750 may also a valve arrangement 701. By way of a non-limiting example, the valve arrangement 701 may include a ball valve configuration including two 3-way ball valves 796a, 796b. The two three-way ball valves 797a, 797b may be coupled to a shaft 798 and controlled/moved by a single actuator 799. The two three-way ball valves 797a, 797b may be rotated to fluidly couple the inlet passage 703 and the outlet passage 705 with a selected one (or more) of the strainer elements 770 in a selected one (or more) of the strainer chambers 776a, 776b. Of course, this is only one example of a valve arrangement 701 consistent with the present disclosure.

The flushing valves 702 may be configured to provide a flow of a flushing fluid to a downstream portion 791 of the strainer chamber 776a, 776b and to remove the flushing fluid (and debris) from an upstream portion 793 of the strainer chamber 676.

The electronic strainer 750 may optionally include one or more purge valves 727. The purge valves 727 may be configured to remove air and/or flushing fluid from the strainer chambers 776a, 776b.

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

### LIST OF REFERENCE CHARACTERS

2 piping system
10 piping apparatus
20 pipeline
30 upstream pipe
32 tubular wall
34 mounting flange
36 fluid flow passage
40 downstream pipe
42 tubular wall
44 mounting flange
46 fluid flow passage
50 electronic strainer
52 strainer housing
54 strainer housing wall
56 upstream mounting flange
57 inlet
58 downstream mounting flange
59 outlet
60 threaded fastener (bolt)
62 threaded fastener (nut)
64 fluid flow passage
66 pressure sensors (66a, 66b)
68 communication lines (68a, 68b)
70 strainer element
72 strainer cap
74 aperture
76 strainer branch
80 outlet port
82 aperture
90 tubular conduit
92 tubular members (92a, 92b, 92c, 92d)
94 fluid flow passage
100 control unit
102 control unit valve
110 processor
120 storage medium
130 communication element
140 electronic circuit board
150 output display
160 power supply
200 remote electronic device
600 piping system
601 valve arrangement
602 flushing valves
603 inlet passage
605 outlet passage
630 an upstream (inlet) pipe
640 a downstream (outlet) pipe
650 electronic strainer 650
670 plurality of strainer elements 670
676 strainer chambers
701 valve arrangement
702 flushing valves
703 inlet passage
705 outlet passage
727 purge valves
734 upstream (inlet) mounting flange
744 downstream (outlet) mounting flange
750 duplex strainer
752 strainer housing
776a, 776b strainer chambers
777 removable lid or cover
787 fasteners
791 downstream portion
793 upstream portion
796a, 796b 3-way ball valves
798 shaft
799 actuator
A angle
LA1 longitudinal axis
LA2 longitudinal axis

What is claimed is:

1. A piping apparatus, comprising:
a strainer comprising a strainer housing including a strainer branch;
wherein the strainer branch is configured to contain a strainer element in the strainer branch;
wherein the strainer housing has a longitudinal length extending from the inlet to the outlet, and the longitudinal length extends along a strainer housing longitudinal axis;
wherein the strainer branch has a longitudinal length which extends along a strainer branch longitudinal axis;
wherein the strainer housing longitudinal axis and the strainer branch longitudinal axis are at an angle (A) with respect to one another;
wherein the strainer housing includes one or more pressure sensors;
wherein, when the strainer element is in the strainer branch, at least one of the one or more pressure sensors is fixed to the strainer housing at a location upstream of the strainer element and/or is fixed to the strainer housing at a location downstream of the strainer element.

2. The piping apparatus of claim 1, further comprising a control unit controller is configured to enter into a cleaning cycle based on an output of the one or more pressure sensors, wherein during the cleaning cycle, the control unit is configured to cause a valve to open for fluid within the strainer and/or solid matter in the strainer element to exit the strainer through the strainer branch.

3. The piping apparatus of claim 2, wherein:
the one or more pressure sensors includes an upstream pressure sensor and a downstream pressure sensor each configured to generate an upstream and downstream output, respectively; and
the control unit is configured to enter into the cleaning cycle based, at least in part, on a comparison of the upstream output and the downstream output and determine if a difference in the outputs meets or exceeds a pre-set threshold.

4. The piping apparatus of claim 3, wherein after a pre-set time, the control unit is further configured close the valve and exit the cleaning cycle.

5. A piping apparatus, comprising:
a strainer comprising a strainer housing including a strainer branch;
wherein the strainer branch is configured to contain a strainer element in the strainer branch;
wherein the strainer housing has a longitudinal length extending from the inlet to the outlet, and the longitudinal length extends along a strainer housing longitudinal axis;
wherein the strainer branch has a longitudinal length which extends along a strainer branch longitudinal axis;
wherein the strainer housing longitudinal axis and the strainer branch longitudinal axis are at an angle (A) with respect to one another;
wherein the strainer housing includes one or more pressure sensors;
wherein, when the strainer element is in the strainer branch, at least one of the one or more pressure sensors is fixed to the strainer housing at a location upstream of the strainer element and/or is fixed to the strainer housing at a location downstream of the strainer element;
a control unit controller is configured to enter into a cleaning cycle based on an output of the one or more pressure sensors, wherein during the cleaning cycle, the control unit is configured to cause a valve to open for fluid within the strainer and/or solid matter in the strainer element to exit the strainer through the strainer branch;
wherein in response to entering the cleaning cycle, the control unit is further configured to communicate with at least one electronic device of a computer network.

6. The piping apparatus of claim 2, wherein:
the one or more pressure sensors includes an upstream pressure sensor configured to generate an upstream output; and
the control unit is configured to enter the cleaning cycle based on a comparison of the upstream output with a high-pressure threshold.

7. The piping apparatus of claim 6, wherein:
after a pre-set time, the control unit is further configured to cause valve to close and exit the cleaning cycle.

8. The piping apparatus of claim 2, wherein:
the one or more pressure sensors includes a downstream pressure sensor configured to generate a downstream output; and
the control unit is configured to enter the cleaning cycle based on a comparison of the downstream output with a low-pressure threshold.

9. The piping apparatus of claim 8, wherein:
after a pre-set time, the control unit is further configured to cause valve to close and exit the cleaning cycle.

10. The piping apparatus of claim 1, wherein the strainer includes a why strainer.

11. The piping apparatus of claim 10, wherein the angle A is an acute angle.

12. The piping apparatus of claim 1, wherein the angle A is a perpendicular angle.

13. The piping apparatus of claim 2, wherein the controller is configured to remotely receive instructions to configure a pressure threshold, a cleaning cycle duration, a valve opening time, and/or a valve closing time.

14. The piping apparatus of claim 2, wherein the controller is configured to repeat the cleaning cycle if the output of the one or more pressure sensors is not within a range.

15. The piping apparatus of claim 14, wherein the controller is configured to repeat the cleaning cycle at least three times.

16. The piping apparatus of claim 14, wherein the controller is configured to cause an alarm to be generated if the output of the one or more pressure sensors is not within a range after a predetermined number of cleaning cycles is reached and/or exceeded.

17. A method of operating a piping apparatus, comprising:
obtaining a strainer comprising a strainer housing including a strainer branch,
wherein the strainer branch is configured to contain a strainer element in the strainer branch;
wherein the strainer housing has a longitudinal length extending from the inlet (57) to the outlet, and the longitudinal length extends along a strainer housing longitudinal axis;
wherein the strainer branch has a longitudinal length which extends along a strainer branch longitudinal axis;
wherein the strainer housing longitudinal axis and the strainer branch longitudinal axis are at an angle (A) with respect to one another;
wherein the strainer housing includes one or more pressure sensors;
wherein, when the strainer element is in the strainer branch, at least one of the one or more pressure sensors is fixed to the strainer housing at a location upstream of the strainer element and/or is fixed to the strainer housing at a location downstream of the strainer element;
establishing electronic communication between the one or more pressure sensors and a control unit;
receiving at least one signal from the one or more pressure sensors at the control unit; and
determining pressure being applied to the one or more pressure sensors by fluid within the strainer based on the at least one signal with the control unit.

18. The method of claim 17, wherein the controller is configured to enter into a cleaning cycle based on an output of the one or more pressure sensors, wherein during the cleaning cycle, the control unit is configured to cause a valve to open for fluid within the strainer and/or solid matter in the strainer element to exit the strainer through the strainer branch.

19. The method of claim 18, wherein the one or more pressure sensors includes an upstream pressure sensor and a downstream pressure sensor configured to generate an upstream output and a downstream output, respectively, the method further comprising:
receiving, at the controller, the upstream and downstream outputs;
comparing the upstream output and the downstream output with the control unit; and
entering into the cleaning cycle if a difference in the upstream output and the downstream output meets and/or exceeds a pre-set threshold.

20. The method of claim 19, further comprising:
closing the valve after a pre-set time with and exiting the cleaning cycle.

21. A method of operating a piping apparatus, comprising:
obtaining a strainer comprising a strainer housing including a strainer branch, wherein the strainer branch is configured to contain a strainer element in the strainer branch;
wherein the strainer housing has a longitudinal length extending from the inlet (57) to the outlet, and the longitudinal length extends along a strainer housing longitudinal axis;
wherein the strainer branch has a longitudinal length which extends along a strainer branch longitudinal axis;
wherein the strainer housing longitudinal axis and the strainer branch longitudinal axis are at an angle (A) with respect to one another;
wherein the strainer housing includes one or more pressure sensors;
wherein, when the strainer element is in the strainer branch, at least one of the one or more pressure sensors is fixed to the strainer housing at a location upstream of the strainer element and/or is fixed to the strainer housing at a location downstream of the strainer element;
establishing electronic communication between the one or more pressure sensors and a control unit;
receiving at least one signal from the one or more pressure sensors at the control unit; and
determining pressure being applied to the one or more pressure sensors by fluid within the strainer based on the at least one signal with the control unit;
wherein the controller is configured to enter into a cleaning cycle based on an output of the one or more pressure sensors, wherein during the cleaning cycle, the control unit is configured to cause a valve to open for fluid within the strainer and/or solid matter in the strainer element to exit the strainer through the strainer branch;
wherein the one or more pressure sensors includes an upstream pressure sensor and a downstream pressure sensor configured to generate an upstream output and a downstream output, respectively, the method further comprising:
receiving, at the controller, the upstream and downstream outputs;
comparing the upstream output and the downstream output with the control unit; and
electronically communicating to at least one electronic device of a computer network with the control unit to report when the control unit enter the cleaning cycle.

22. The method of claim of claim 18, wherein the one or more pressure sensors includes an upstream pressure sensor configured to generate an upstream output, the method further comprising:
receiving, at the controller, the upstream output; and
entering into the cleaning cycle based on a comparison of the upstream output with a high-pressure threshold.

23. The method of claim 22, wherein if the high-pressure threshold is meet or exceeded, the control unit is configured to enter the cleaning cycle and, after a pre-set time, the controller is configured to cause the valve to close and exit the cleaning cycle.

24. The method of claim 18, wherein the one or more pressure sensors includes a downstream pressure sensor configured to generate a downstream output;
receiving, at the controller, the downstream output; and
entering into the cleaning cycle based on a comparison of the downstream output with a low-pressure threshold.

25. The method of claim 24, wherein if the low-pressure threshold is meet or exceeded, the control unit is configured to enter the cleaning cycle and, after a pre-set time, the controller is configured to cause the valve to close and exit the cleaning cycle.

26. The method of claim 17, further comprising remotely receiving instructions to configure a pressure threshold, a cleaning cycle duration, a valve opening time, and/or a valve closing time at the controller.

27. The method of claim 18, wherein the controller is configured to repeat the cleaning cycle if the output of the one or more pressure sensors is not within a range.

28. The method of claim 27, wherein the controller is configured to repeat the cleaning cycle three times.

29. The method of claim 18, wherein the controller is configured to cause an alarm to be generated if the output of the one or more pressure sensors is not within a range after a predetermined number of cleaning cycles is reached and/or exceeded.

30. A piping apparatus, comprising:
a strainer comprising a strainer housing including a strainer branch;
wherein the strainer branch is configured to contain a strainer element in the strainer branch;
wherein the strainer housing has a longitudinal length extending from the inlet to the outlet, and the longitudinal length extends along a strainer housing longitudinal axis;
wherein the strainer branch has a longitudinal length which extends along a strainer branch longitudinal axis;
wherein the strainer housing longitudinal axis and the strainer branch longitudinal axis are at an angle (A) with respect to one another;
wherein the strainer housing includes one or more temperature sensors;
wherein, when the strainer element is in the strainer branch, at least one of the one or more temperature sensors is fixed to the strainer housing at a location upstream of the strainer element and/or is fixed to the strainer housing at a location downstream of the strainer element.

31. The piping apparatus of claim 30, wherein the strainer housing includes one or more pressure sensors.

32. A piping apparatus, comprising:
a strainer comprising:
a strainer housing including:
an inlet passage;
an outlet passage; and
a first and a second strainer chamber each including a strainer element; and
a valve arrangement configured to selectively fluidly couple the inlet passage and the outlet passage to the first strainer chamber when in a first configuration and to selectively fluidly couple the inlet passage and the outlet passage to the second strainer chamber when in a second configuration;
one or more flushing valves configured to selectively provide a flow of a flushing fluid through at least a portion of a selected one or more of the first and/or second strainer chambers to remove contaminants/debris from the strainer element within the selected one or more of the first and/or second strainer chambers; and
one or more one or more pressure sensors configured to be located upstream of the first and/or second strainer elements and/or located downstream of the first and/or second strainer elements.

33. The piping apparatus of claim 32, further comprising a controller is configured to enter into a cleaning cycle based on an output of the one or more pressure sensors, wherein during the cleaning cycle, the control unit is configured to cause the valve arrangement to transition from the first configuration to the second configuration.

34. The piping apparatus of claim 33, wherein during the cleaning cycle, the control unit is further configured to cause the one or more flushing valves to provide the flow of the flushing fluid to the first strainer chamber.

35. The piping apparatus of claim 34, wherein:
the one or more pressure sensors includes an upstream pressure sensor and a downstream pressure sensor each configured to generate an upstream and downstream output, respectively; and
the control unit is configured to enter into the cleaning cycle based, at least in part, on a comparison of the upstream output and the downstream output and determine if a difference in the outputs meets or exceeds a pre-set threshold.

36. The piping apparatus of claim 35, wherein after a pre-set time, the control unit is further configured close the one or more flushing valves and exit the cleaning cycle.

37. The piping apparatus of claim 34, wherein:
the one or more pressure sensors includes an upstream pressure sensor configured to generate an upstream output; and
the control unit is configured to enter the cleaning cycle based on a comparison of the upstream output with a high-pressure threshold.

38. The piping apparatus of claim 6, wherein:
after a pre-set time, the control unit is further configured to cause the one or more flushing valves to close and exit the cleaning cycle.

39. The piping apparatus of claim 35, wherein fluid configured to flow into the inlet passage and exit the outlet passage substantially uninterrupted while the valve arrangement transitions from the first configuration to the second configuration and the one or more flushing valves provide the flow of the flushing fluid to the first strainer chamber.
